(19) United States
(12) Patent Application Publication
(10) Pub. No.: US 2015/0163580 A1
(43) Pub. Date: Jun. 11, 2015

(54) SYSTEMS FOR EARPHONE CABLE MANAGEMENT

(71) Applicants: Resh Wallaja, San Francisco, CA (US); William Guie Rivard, Menlo Park, CA (US)

(72) Inventors: Resh Wallaja, San Francisco, CA (US); William Guie Rivard, Menlo Park, CA (US)

(21) Appl. No.: 14/563,530

(22) Filed: Dec. 8, 2014

Related U.S. Application Data
(60) Provisional application No. 61/913,353, filed on Dec. 8, 2013.

(51) Int. Cl. H04R 1/10

(52) U.S. Cl. CPC H04R 1/1033

(57) ABSTRACT

Transforming an earphone system from a topology comprising loose ends to a topology comprising one or more loops inhibits knot formation. A cable management device provides for coupling an electrical jack to one or more earbuds comprising the earphone system, thereby eliminating topological loose ends and consequently inhibiting knot formation by eliminating opportunities for knot nucleation at the topological loose ends. A user may conveniently configure their earphones for storage by coupling the electrical jack to each earbud prior to storage. Upon retrieval from storage, the user is advantageously relieved from needing to unknot their earphone system.

### CLAIM OF PRIORITY

This application claims the benefit of U.S. Provisional Application No. 61/913,353 (Attorney Docket No. EBC-001) titled “SYSTEMS FOR EARPHONE CABLE MANAGEMENT,” filed Dec. 8, 2013, the entire content of which is incorporated herein by reference.

### FIELD OF THE INVENTION

Embodiments of the present invention relate generally to earphone systems, and more specifically to systems for earphone cable management.

### BACKGROUND

A typical earphone system includes an electrical jack coupled to one or two earbuds via an electrical cable. A line topology having two loose ends may represent an earphone system with one earbud, while a “Y” topology having three loose ends may represent an earphone system with two earbuds. When in use, the jack is typically plugged into a device such as a mobile phone, music player, tablet computer, etc. When in storage, the jack and each earbud each comprise a loose end that is highly prone to knot nucleation. Knot nucleation is a process in which a loose end of a string moves through one or more loops associated with one or more sections of a string and forms one or more knots. Each loose end of a line topology and each loose end of a Y topology may independently form knots. The knot nucleation process is promoted by movement and confinement, both characteristics of common storage scenarios of a typical earphone system, such as when an earphone system is stored within a backpack, purse, pocket, pouch, and the like. When knots form in the electrical cable, such as due to knot nucleation associated with common storage techniques, the earphone system becomes tangled and may be difficult to untangle for subsequent use.

Prior art earphone systems attempt to address the problem of knot formation through the application of bulky devices or inconvenient techniques. For example, one category of solution involves a spring-loaded roller mechanism that the user may deploy to roll-up the electrical cable for storage, thereby minimizing the likelihood of knot formation. A typical spring-loaded roller can be quite bulky compared to the balance of the earphone system. A typical spring-loaded roller also remains attached to the earphone system, introducing a constant inconvenience. Other solutions require the user to manually roll up the electrical cable on a customized storage structure, which may be quite bulky. Such solutions may be advantageous over sprint-loaded rollers because the storage structure need not be attached when the earphone system is being actively used. However, the process of rolling up the earphone system in conformance with the storage structure may be quite inconvenient and time consuming.

Thus, there is a need for addressing this and/or other issues associated with the prior art.

### SUMMARY

An earphone system, comprising an electrical jack, an earbud, and a cable management device is disclosed herein. The electrical jack is configured to transmit an electrical signal from an audio host to an electrical cable. The earbud is coupled to the electrical cable and configured to convert the electrical signal into an acoustic signal. The cable management device is coupled to the electrical jack and to the earbud to configure the electrical cable into a loop topology.

A user may conveniently configure their earphones for storage by coupling the electrical jack to the earbud prior to storage. Upon retrieval from storage, the user is advantageously relieved from needing to unknot their earphone system because the loop topology inhibits knot formation.

### BRIEF DESCRIPTION OF THE DRAWINGS

FIG. 1 illustrates a prior art earphone system comprising two earbuds.

FIG. 2A illustrates an earphone system that includes a cable management device, according to one embodiment of the present invention.

FIG. 2B illustrates the earphone system of FIG. 2A in a storage configuration, according to one embodiment of the present invention.

FIGS. 2C through 2F illustrate different exemplary configurations of the cable management device of FIG. 2A, according to one or more embodiments of the present invention.

FIG. 2G illustrates an electrical jack being inserted into a receptacle associated with the cable management device of FIG. 2A, according to one embodiment of the present invention.

FIG. 2H illustrates an electrical jack being inserted into a receptacle associated with the cable management device of FIG. 2A, according to one embodiment of the present invention.

FIGS. 3A through 3F illustrate cross sections of exemplary configurations of a cable management device, according to one or more embodiments of the present invention.

FIGS. 4A through 4D illustrate cross sections of exemplary configurations of a cable management device, according to one or more embodiments of the present invention.

FIG. 5A illustrates an earphone system in a storage configuration, according to one embodiment of the present invention.

FIG. 5B illustrates an alternative engagement position of the electrical jack within a cable management device, according to one embodiment of the present invention.

FIG. 5C illustrates an alternative earbud position associated with a cable management device, according to one embodiment of the present invention.

FIG. 6A illustrates an earphone system in a storage configuration, according to one embodiment of the present invention.

FIG. 6B illustrates a cross section of an exemplary cable management device, according to one embodiment of the present invention.

FIG. 6C illustrates a cross section of another exemplary cable management device, according to one embodiment of the present invention.

FIG. 7A illustrates an earphone system being disposed into a storage configuration, according to one embodiment of the present invention.

FIG. 7B illustrates engagement elements comprising a cable management device, according to one embodiment of the present invention.

FIG. 7C illustrates engagement elements disposed to receive an electrical jack, according to one embodiment of the present invention.

FIG. 7D illustrates the engagement elements receiving the electrical jack, causing the earphone system to begin to enter a storage configuration, in accordance with one embodiment of the present invention.

FIG. 7E illustrates a cross section of two engagement elements having a closed engagement geometry, according to one embodiment of the present invention.

FIG. 7F illustrates a cross section of two engagement elements having an open engagement geometry, according to one embodiment of the present invention.

FIG. 7G illustrates a cross section of two engagement elements coupled together and ready to receive the electrical jack, according to one embodiment of the present invention.

FIG. 7H illustrates an earphone system in a storage configuration, according to one embodiment of the present invention.

FIG. 8A illustrates an earphone system being disposed into a storage configuration, according to one embodiment of the present invention.

FIG. 8B illustrates a cross section of an electrical jack comprising a cable management device, according to one embodiment of the present invention.

FIG. 8C illustrates the earphone system of FIG. 8A disposed in a storage configuration, according to one embodiment of the present invention.

FIG. 8D illustrates a cross section of the electrical jack coupled to each of two earbud stems, thereby disposing the earphone system into a storage configuration, according to one embodiment of the present invention.

FIG. 8E illustrates an alternative earphone system, whereby each earbud stem comprises a substantially cylindrical shaft being disposed into a storage configuration, according to one embodiment of the present invention.

FIG. 8F illustrates the earphone system of FIG. 8E disposed in a storage configuration, according to one embodiment of the present invention.

FIG. 9A illustrates an earphone system being disposed into a storage configuration, according to one embodiment of the present invention.

FIG. 9B illustrates the earphone system of FIG. 9A disposed in a storage configuration, according to one embodiment of the present invention.

FIG. 9C illustrates a cross section of the earphone system of FIG. 9A, according to one embodiment of the present invention.

FIG. 9D illustrates a cross section of the earphone system of FIG. 9A, according to another embodiment of the present invention.

FIG. 9E illustrates a cross section of the earphone system of FIG. 9A, according to yet another embodiment of the present invention.

FIG. 9F illustrates a cross section of the earphone system of FIG. 9A, configured to include retention structures, according to one embodiment of the present invention.

FIG. 9G illustrates a cross section of the earphone system of FIG. 9A disposed in a storage configuration, according to one embodiment of the present invention.

FIG. 10A illustrates a magnetic element comprising a first attachment device, according to one embodiment of the present invention.

FIG. 10B illustrates a magnetic element comprising a second attachment device, according to one embodiment of the present invention.

FIG. 10C illustrates the second attachment device being disposed into a storage configuration, according to one embodiment of the present invention.

FIG. 10D illustrates a cross section of the earphone system of FIG. 9A configured to include two instances of the second attachment device, according to one embodiment of the present invention.

FIG. 10E illustrates a cross section of the earphone system of FIG. 10D disposed in a storage configuration, according to one embodiment of the present invention.

FIG. 11A illustrates an earphone system disposed in a storage configuration, according to one embodiment of the present invention.

FIG. 11B illustrates a cross section of a cable management device, according to one embodiment of the present invention.

FIG. 11C illustrates a cross section of the cable management device disposed in a storage configuration, according to one embodiment of the present invention.

FIG. 11D illustrates a cross section of the cable management device configured to include magnetic attachment devices, according to one embodiment of the present invention.

FIG. 12A illustrates a cable management device disposed in a storage configuration, according to one embodiment of the present invention.

FIG. 12B illustrates the cable management device of FIG. 11A prepared to dispose an earphone system into a storage configuration, according to one embodiment of the present invention.

### DETAILED DESCRIPTION

Earphone systems are commonly used with audio host devices such as mobile phones, mobile music players, tablet computers, and other computing platforms configured to generate an audio signal. An earphone system may include one earbud or two earbuds coupled to an electrical jack through an electrical cable. The electrical jack is configured to electronically couple the earphone system to an audio host device. Each earbud is configured to convert an electronic signal transmitted through the electrical jack to a corresponding acoustic signal. An earphone system may also include a microphone integrated within an earbud or disposed along the electrical cable. The microphone is configured to convert an acoustic signal into an electronic signal for transmission through the electrical jack.

The electrical jack and each earbud each represent a loose end prone to knot nucleation. To store the earphone system, a user commonly winds the electrical cable along with the earbuds and electrical jack into a bundle or simply wads these components into a bundle for storage within a pocket or pouch. This common storage technique creates a productive environment for knot nucleation associated with each loose end. Knot formation and tightening occurs while the earphone system is stored, with movement and confinement promoting further knotting and further tangling.

Embodiments of the present invention inhibit knot nucleation, the primary cause of knotting and tangling while an earphone system is stored, by eliminating loose ends during storage. Loose ends are eliminated by removably binding the electrical jack and each of one or two earbuds together to form a loop topology. The loop topology may include one loop, or a plurality of loops, but no loose ends. Without loose ends, knot nucleation is highly inhibited, significantly diminishing any knotting or tangling of the earphone system while being stored. Without knots in the electrical cable, a user may simply and conveniently shake the earphone system into a usable configuration.

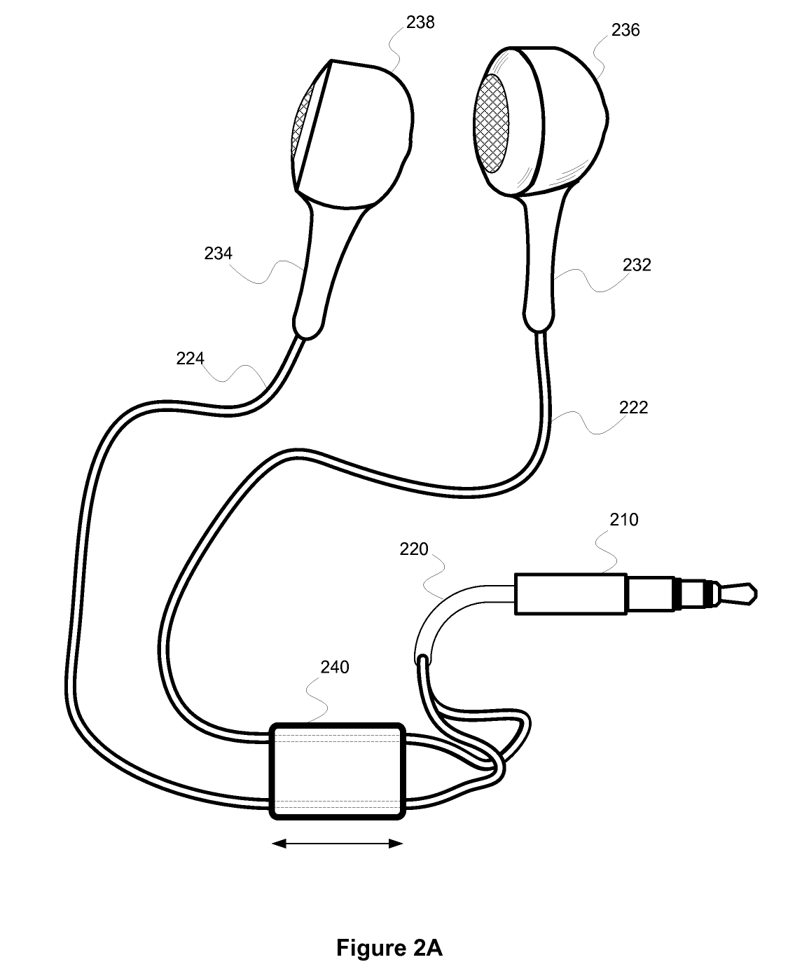

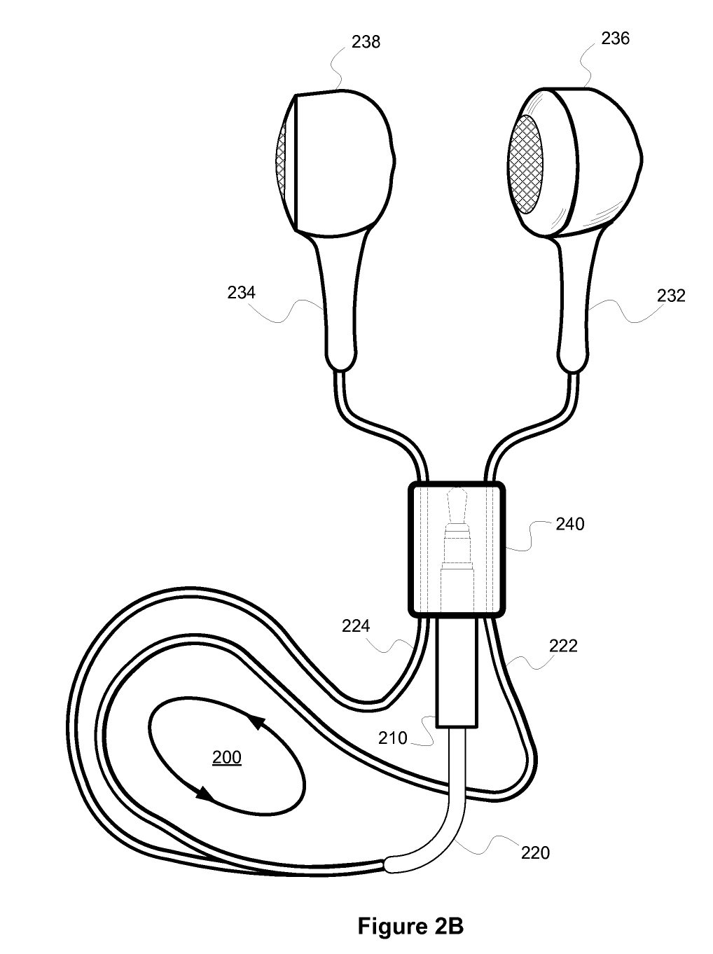

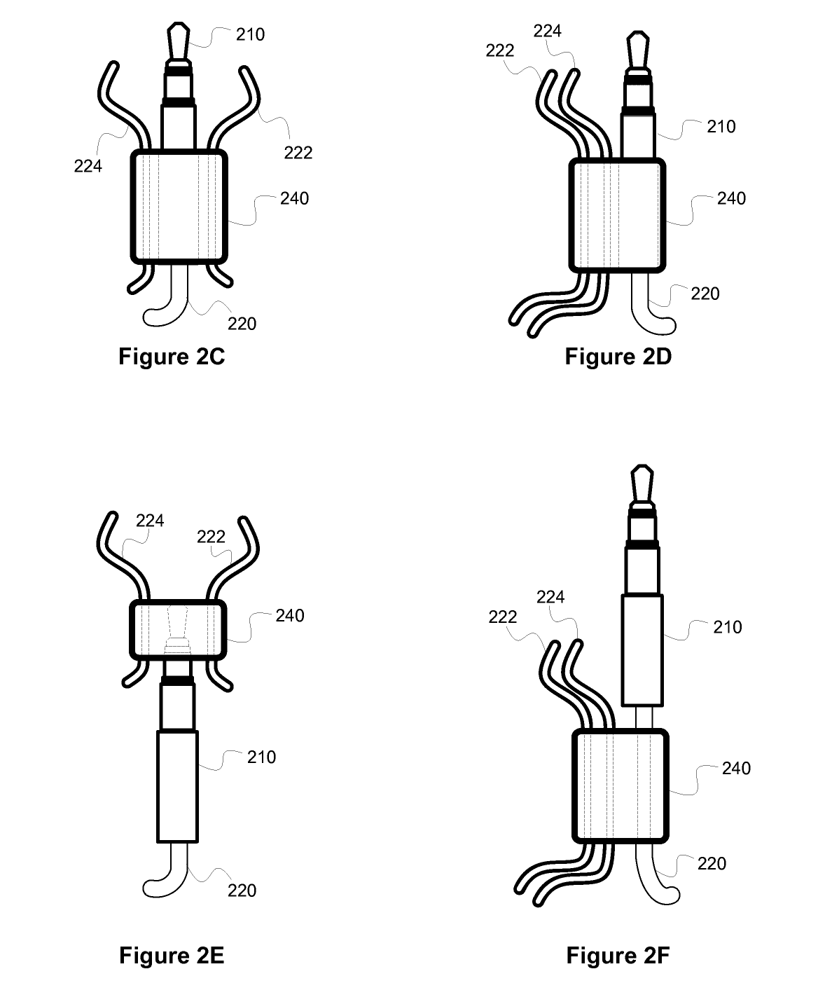

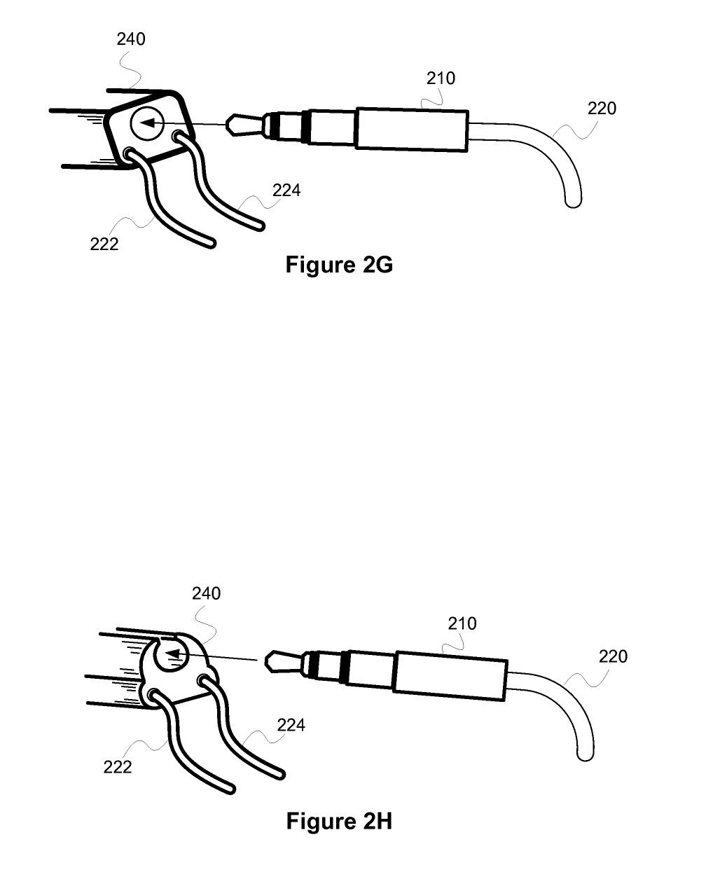

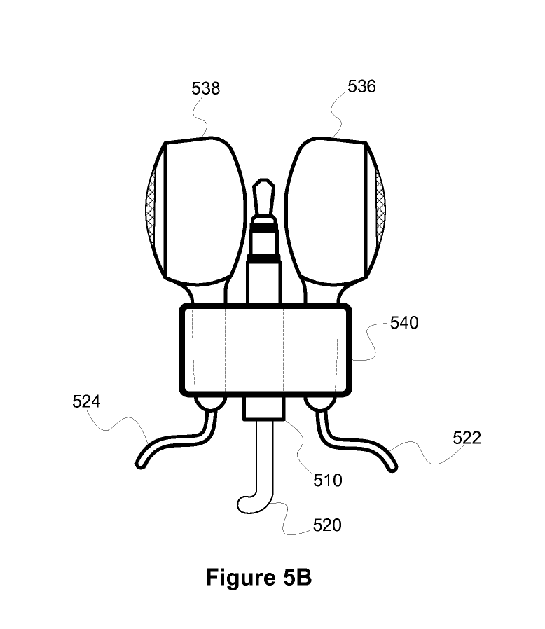

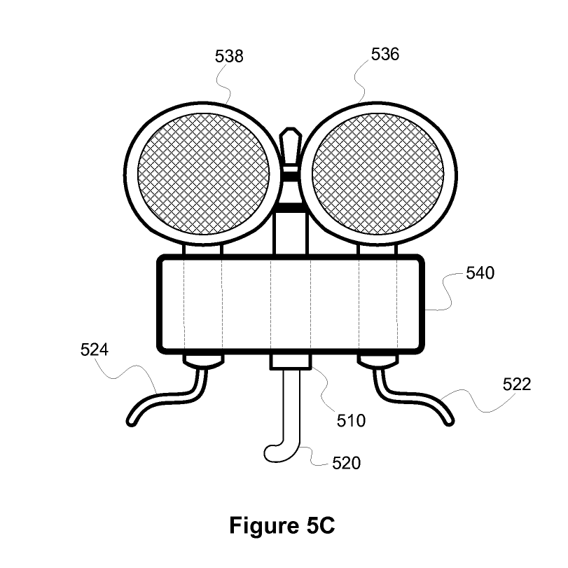

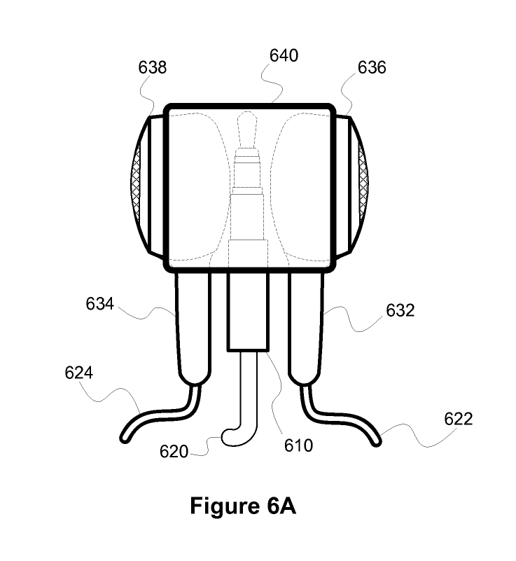

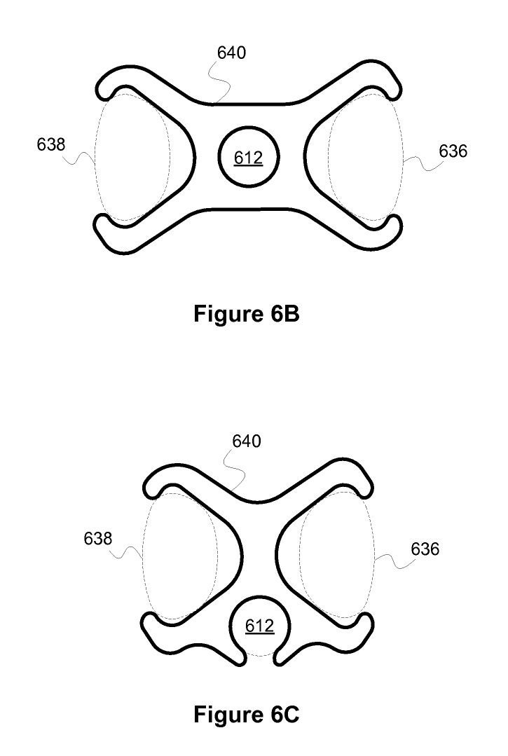

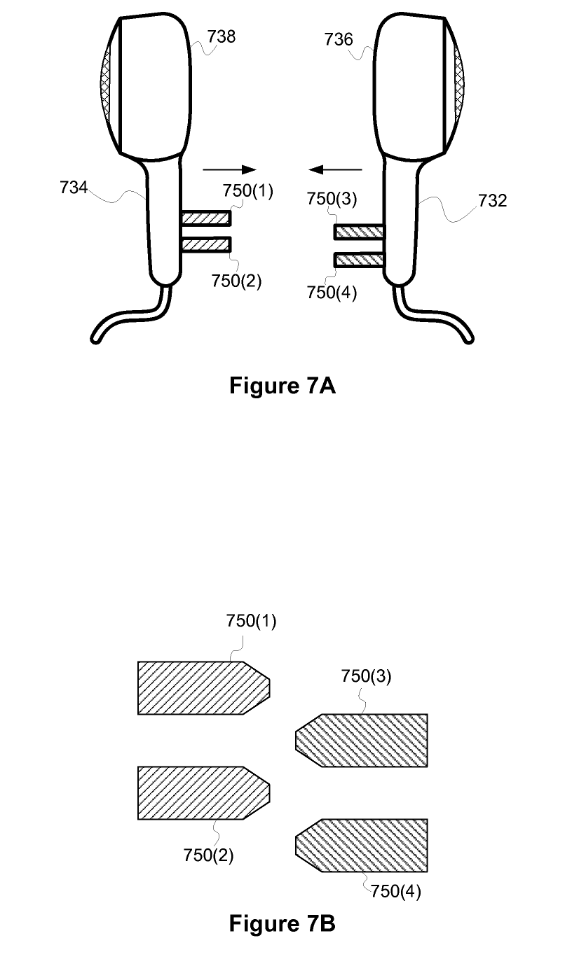

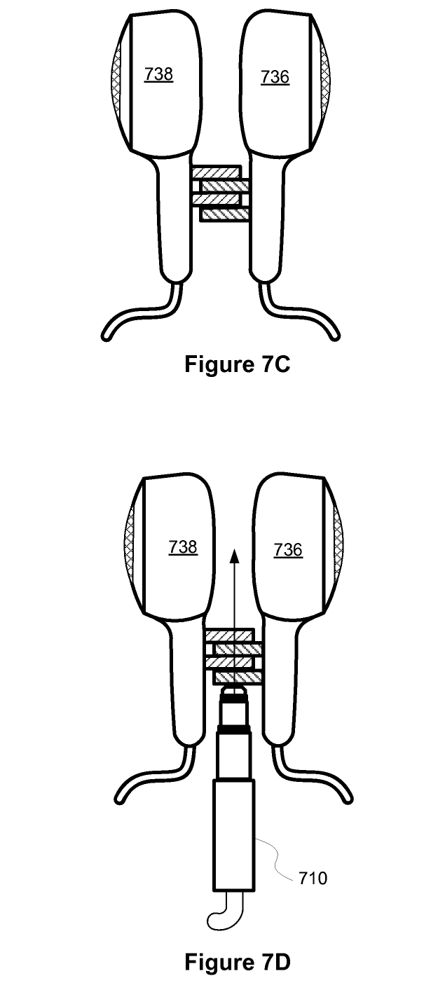

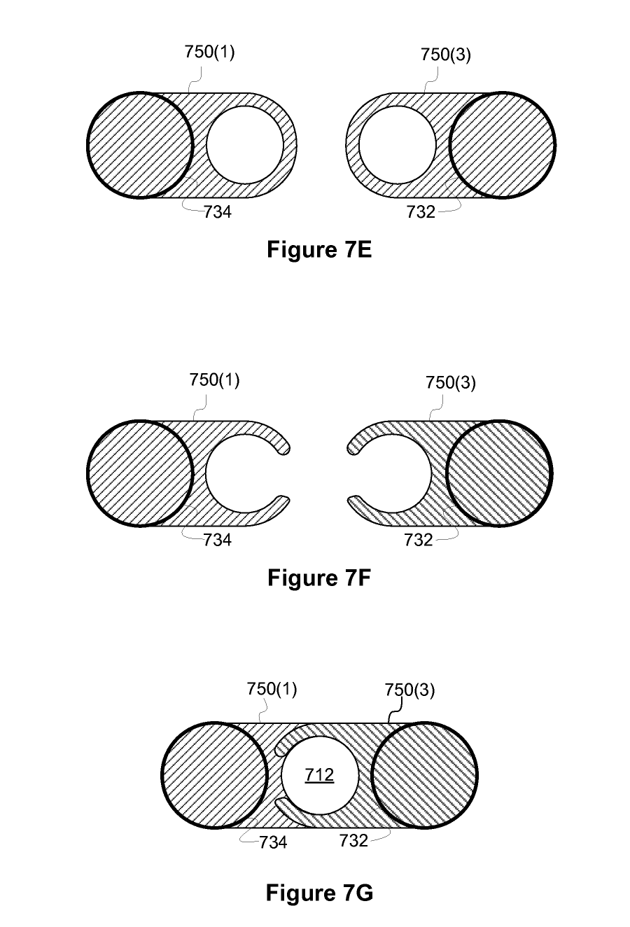

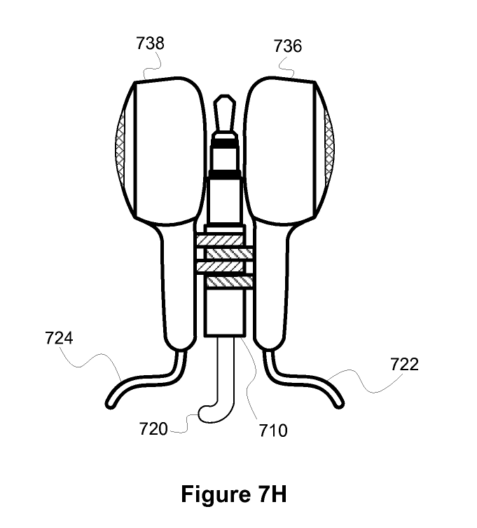

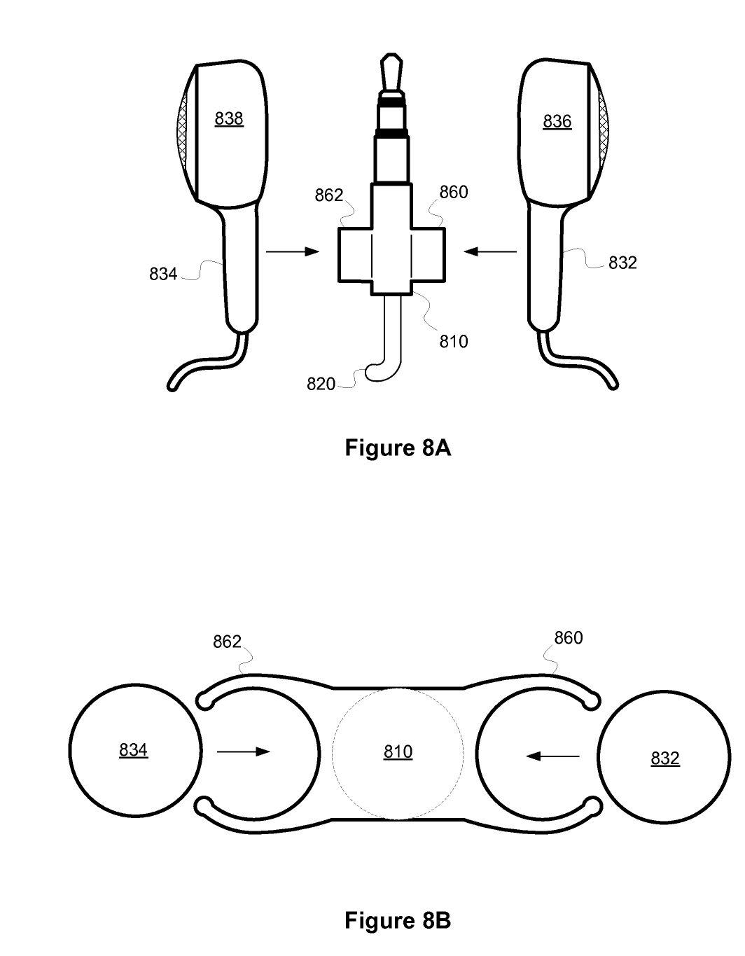

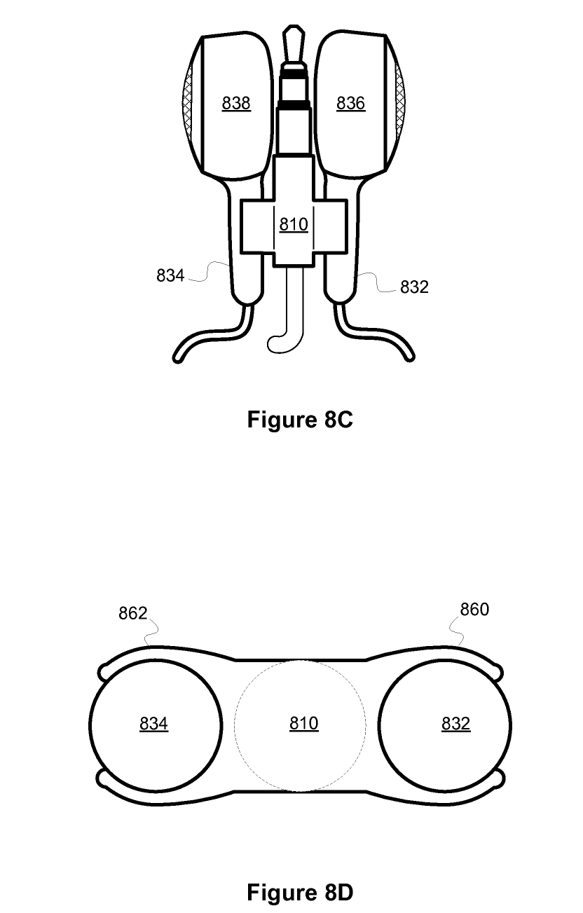

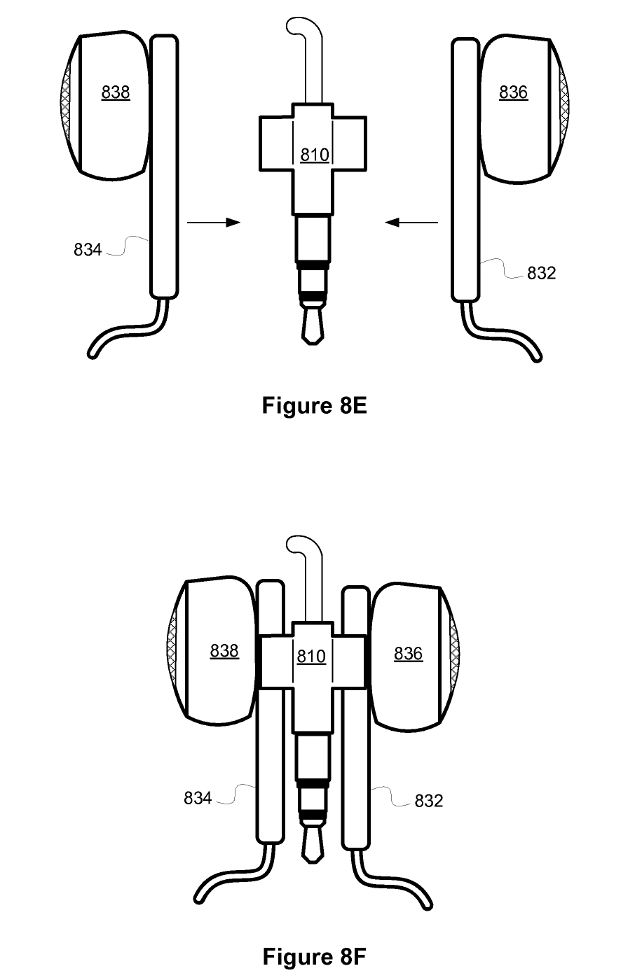

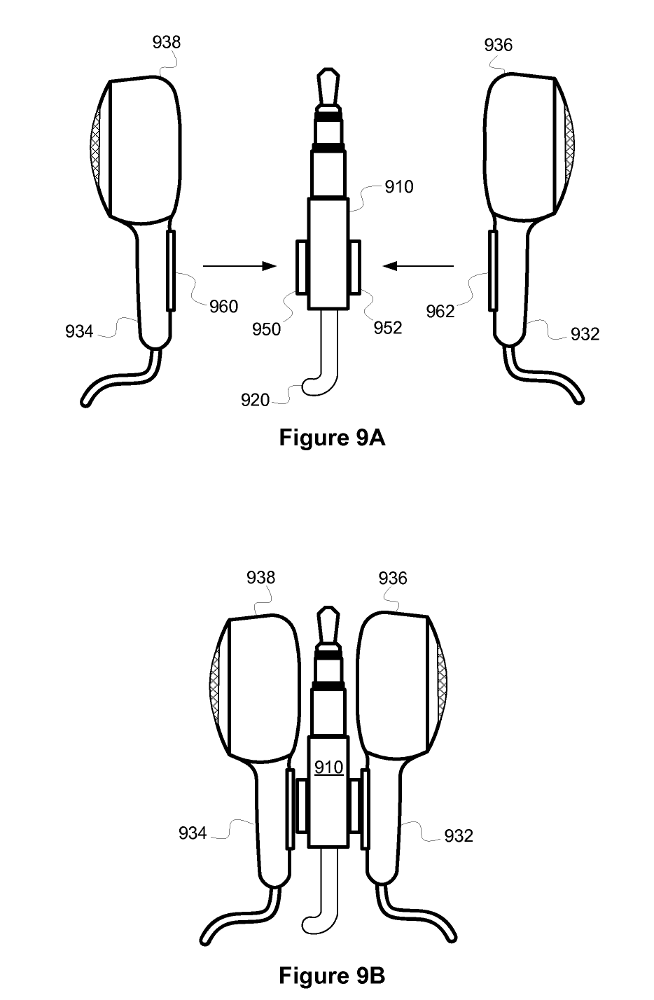

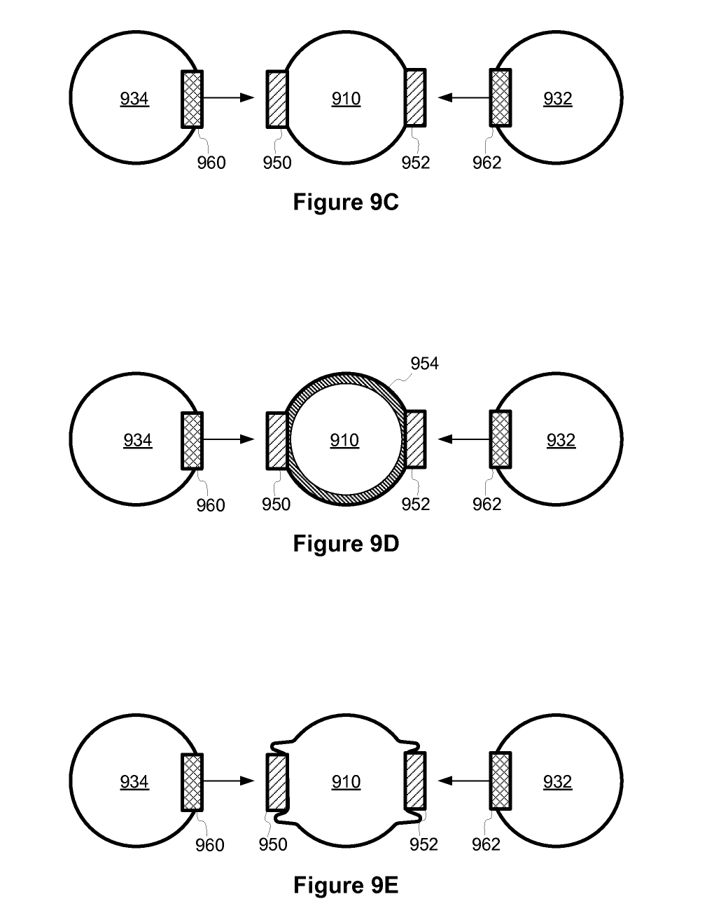

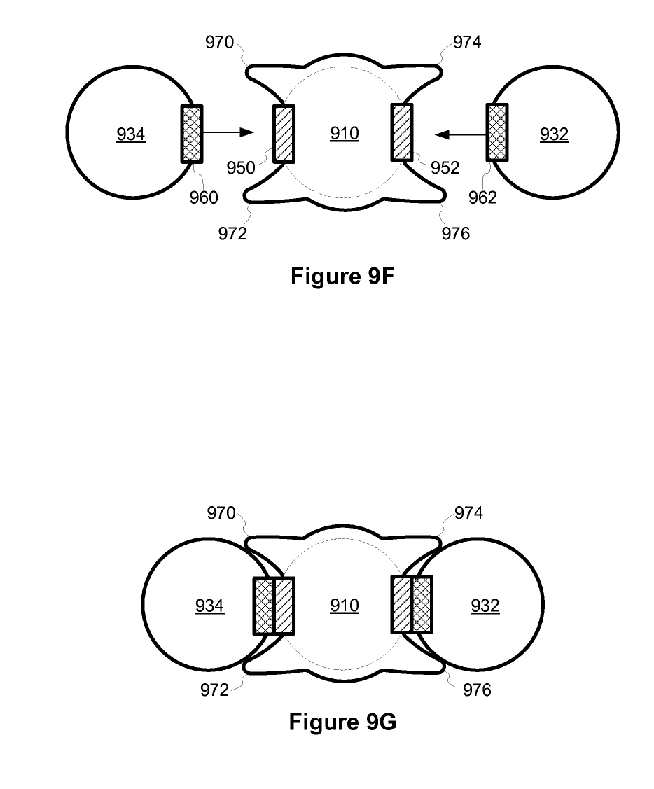

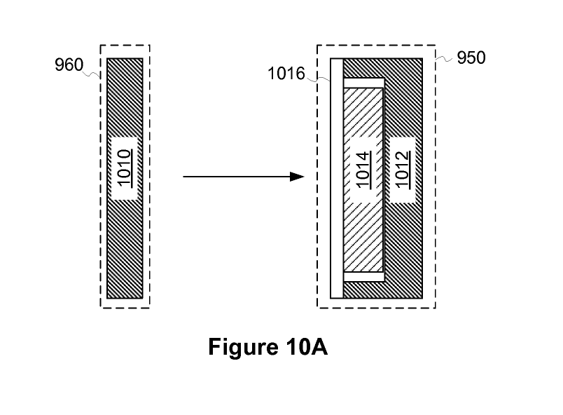

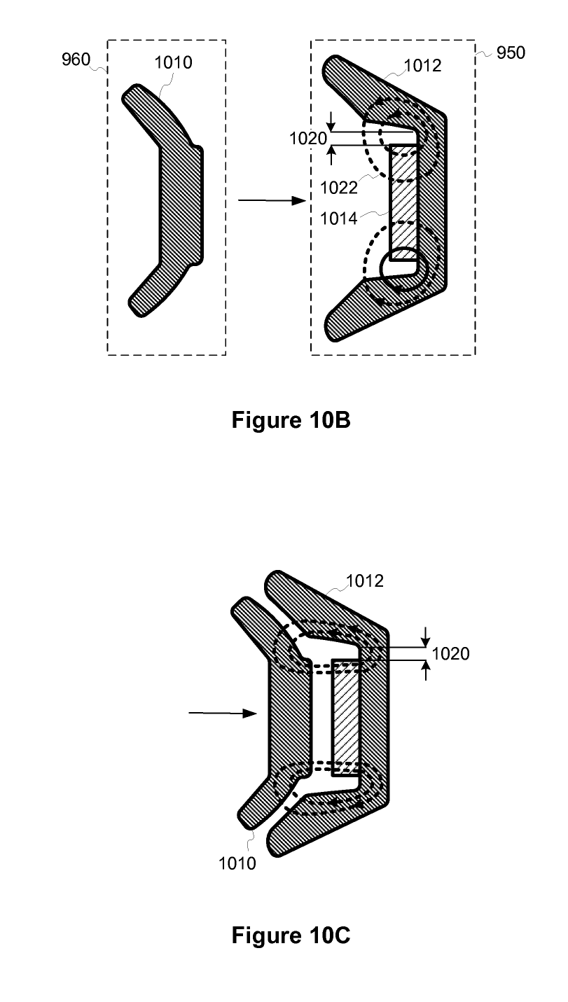

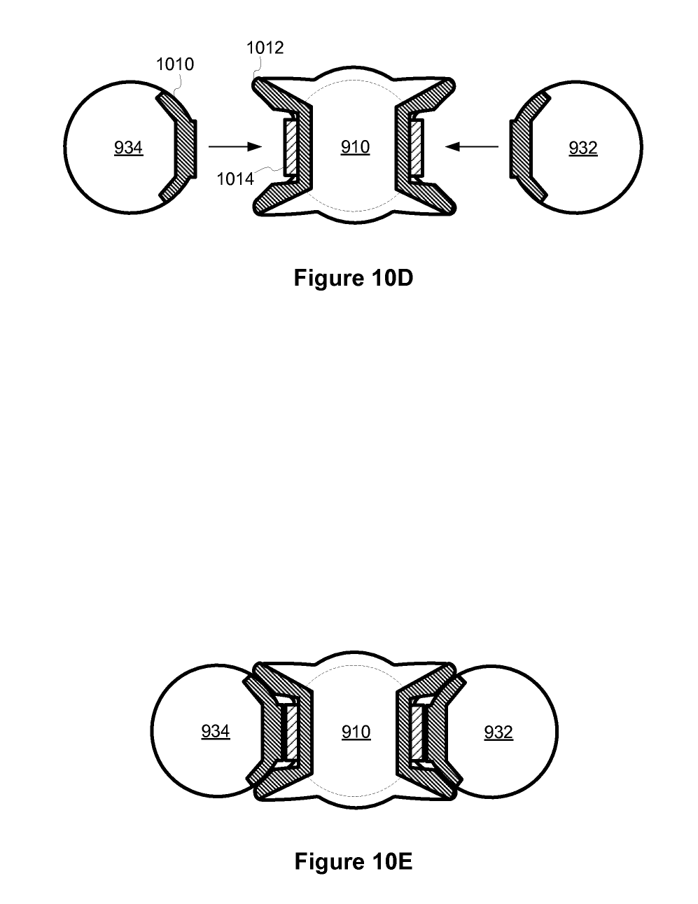

Certain embodiments implement a cable management device coupled to the electrical cable and configured to be coupled to the electrical jack to form a loop topology. The cable management device may be slid along the electrical cable to close proximity with the earbuds, and then coupled to the electrical jack to form a loop topology. This embodiment is described below in FIGS. 2A-4D. In a second embodiment, a cable management device is configured to be coupled to stems of one or more earbuds and to the electrical jack to form a loop topology, as discussed below FIGS. 5A-5C. In a third embodiment, the cable management device is configured to be coupled to the earbuds and to the electrical jack to form a loop topology. An exemplary implementation of this embodiment is described below in FIGS. 6A-6C. In a fourth embodiment, each earbud in an earphone system includes an attachment device configured to be coupled to the electrical jack to form a loop topology. One or more attachment devices collectively form a cable management device, described below in FIGS. 7A-7H. In a fifth embodiment, the electrical jack includes a cable management device, as described below in FIGS. 8A-8F. The cable management device is configured to removably couple each earbud to the electrical jack to form a loop topology. In a sixth embodiment, an attachment device is configured to couple an earbud to the electrical jack, as described below in FIGS. 9A-9G. FIG. 10A describes a first attachment device comprising a magnet component and a matching ferromagnetic component fabricated using a ferromagnetic material such as soft iron or steel that may be coupled to the magnet. An earphone system comprising two earbuds may be implemented using two attachment devices, comprising a total of two magnet components and two ferromagnetic components. A second magnetic attachment device is described in FIGS. 10B-10E.

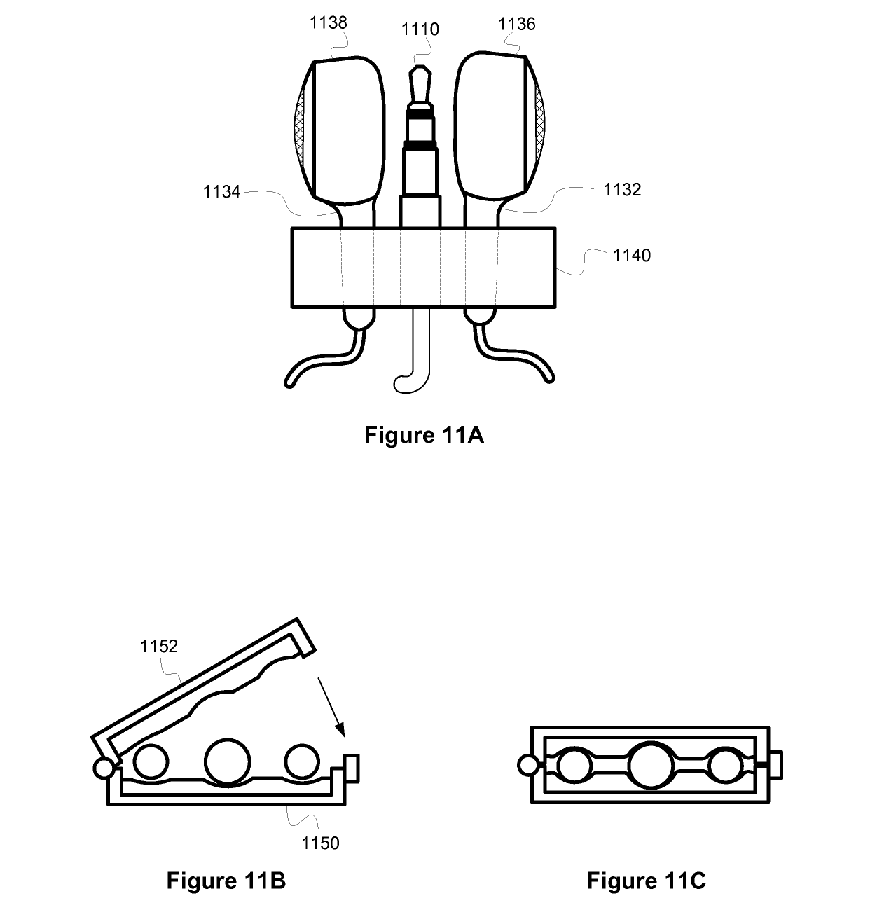

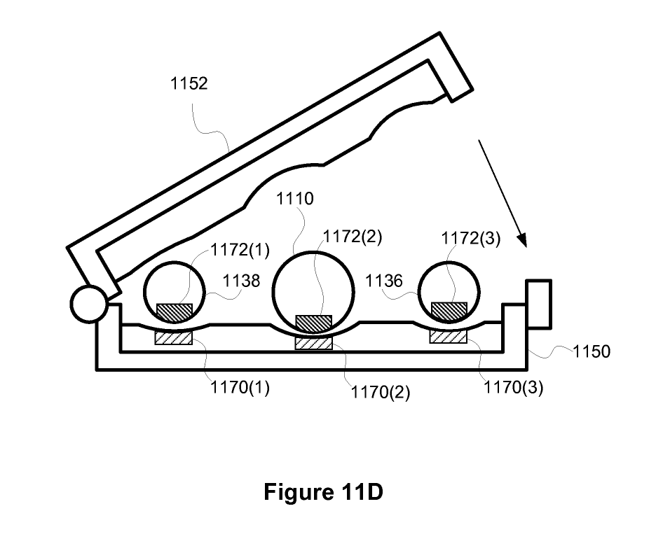

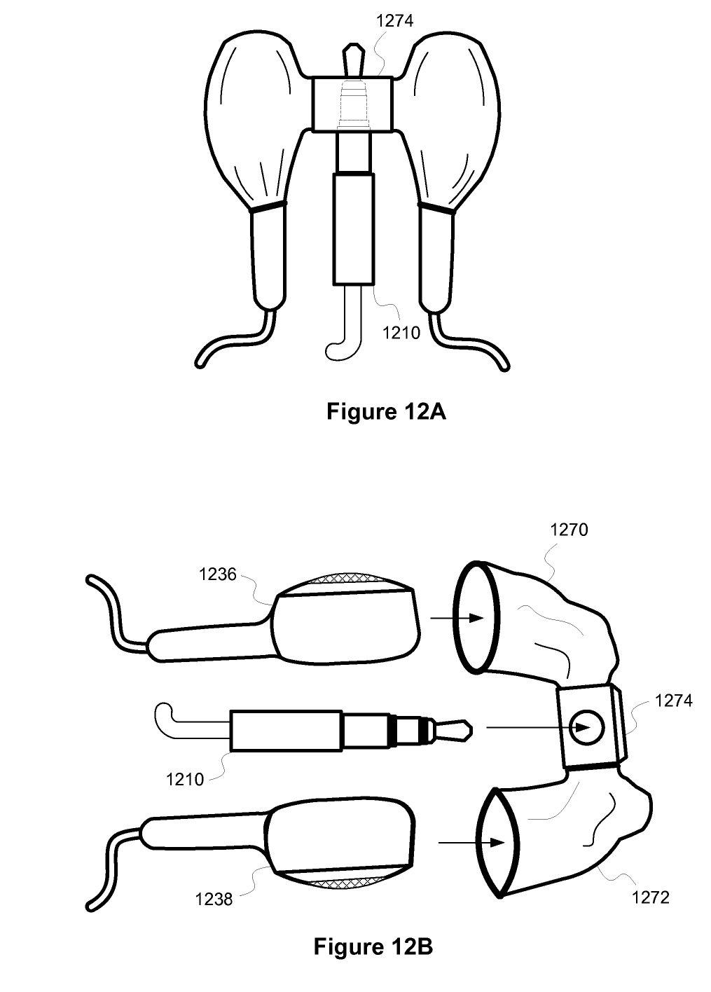

In a seventh embodiment, a cable management device comprises a clamp structure, described below in FIGS. 11A-11C. The clamp structure is configured to retain the electrical jack and each earbud associated with the earphone system, to form a loop topology. In an eighth embodiment, the cable management device comprises a fabric capture structure and a receptacle configured to be removably coupled to the electrical jack, as described below in FIGS. 12A-12B. The fabric capture structure is configured to retain one or more earbuds within an earphone system. The fabric capture structure may include an appropriately sized sack, tube, or noose structure into which an earbud may be removably and snugly disposed. When each earbud is disposed within a corresponding fabric capture structure and the electrical jack is coupled to the receptacle, a loop topology may be formed.

These and other embodiments may be implemented in conjunction with an earphone system to transform an earphone system topology comprising loose ends to a topology comprising one or more loops without departing the scope and spirit of the present invention. For example a cable management device comprising other fasteners such as hooks, tongue and groove pairs, protuberances with matching cavity pairs, and the like may be configured to couple the electrical jack to one or more earbuds to dispose an earphone system into a loop topology configuration.

While embodiments of the present invention are described herein in conjunction with an earphone system comprising earbuds, other embodiments may be directed to any technically feasible head-mounted audio device. For example, in one embodiment, the earphone system comprises a bone conduction transducer coupled to an electrical cable, which is further coupled directly to an electrical jack. The electrical jack may be coupled directly to the bone conduction transducer, thereby disposing the earphone system into a storage configuration having a loop topology.

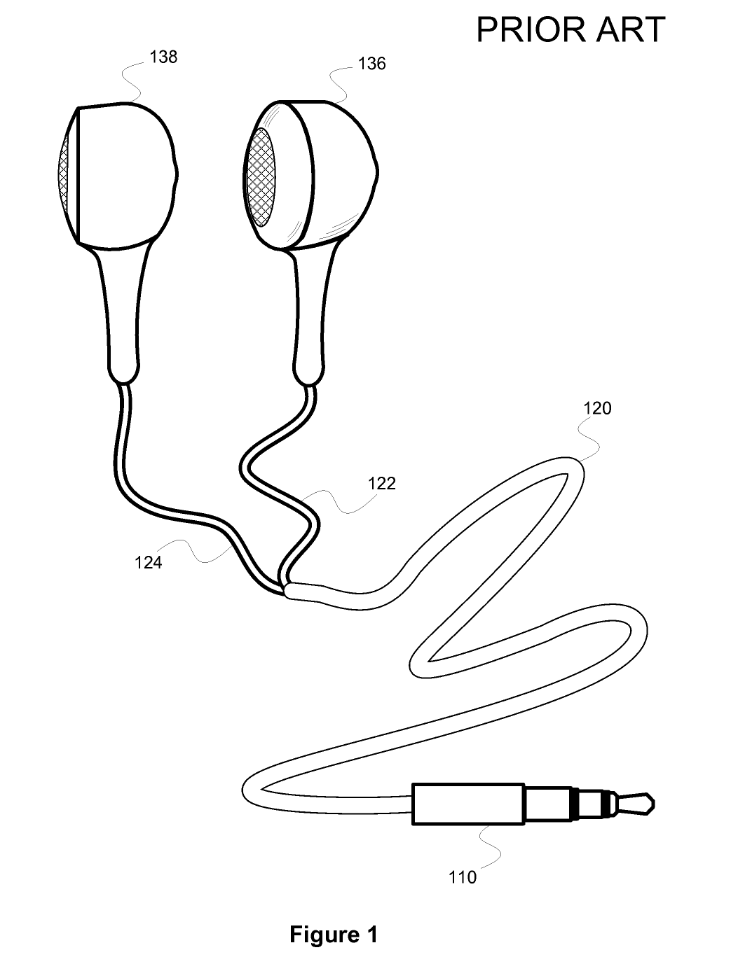

FIG. 1 illustrates a prior art earphone system comprising two earbuds 136, 138. As shown, each earbud is coupled to an electrical jack 110 through a system of electrical cables 120, 122, 124. When the earphone system is being actively used, the electrical jack 110 is coupled to an electronic device such as a cellular phone, music player, or tablet computer. When the earphone system is being stored, each respective element is confined into a storage volume such as a pocket, pouch, canister, or the like. When in storage, knot nucleation commonly occurs, causing the electrical cables to become knotted and tangled. Attempts to reducing knotting and tangling such as wrapping the electrical cables around the electronic device typically aggravate rather reduce the knot forming process because knot nucleation of loose ends is typically enhanced in the presence of preformed loops.

FIG. 2A illustrates an earphone system that includes a cable management device 240, according to one embodiment of the present invention. In one embodiment, earphone system includes the cable management device 240, at least one of earbuds 236, 238, electrical cables 220, 222, 224, and electrical jack 210. Earbuds 236, 238 may comprise stems 232, 234, respectively. In one embodiment cable management device 240 is configured to slide along at least electrical cables 222, 224. When configuring the earphone system for storage, the cable management device 240 may be slid close to the earbuds 236, 238.

FIG. 2B illustrates the earphone system of FIG. 2A in a storage configuration, according to one embodiment of the present invention. As shown, cable management device 240 is positioned close to the earbuds 236, 238, and electrical jack 210 has been coupled to the cable management device 240. In this configuration, the topological loose end defined by the electrical jack 210 is eliminated and the topology for related cables is transformed into a loop 200. With earbuds 236, 238 sufficiently close to the cable management device 240, knot nucleation is inhibited.

In an alternative embodiment, only one earbud is implemented and a microphone is optionally disposed along an electrical cable comprising the earphone system.

FIGS. 2C through 2F illustrate different exemplary configurations of the cable management device of FIG. 2A, according to one or more embodiments of the present invention.

FIG. 2G illustrates an electrical jack 210 being inserted into a receptacle associated with the cable management device of FIG. 2A, according to one embodiment of the present invention.

FIG. 2H illustrates an electrical jack 210 being inserted into a receptacle associated with the cable management device of FIG. 2A, according to one embodiment of the present invention.

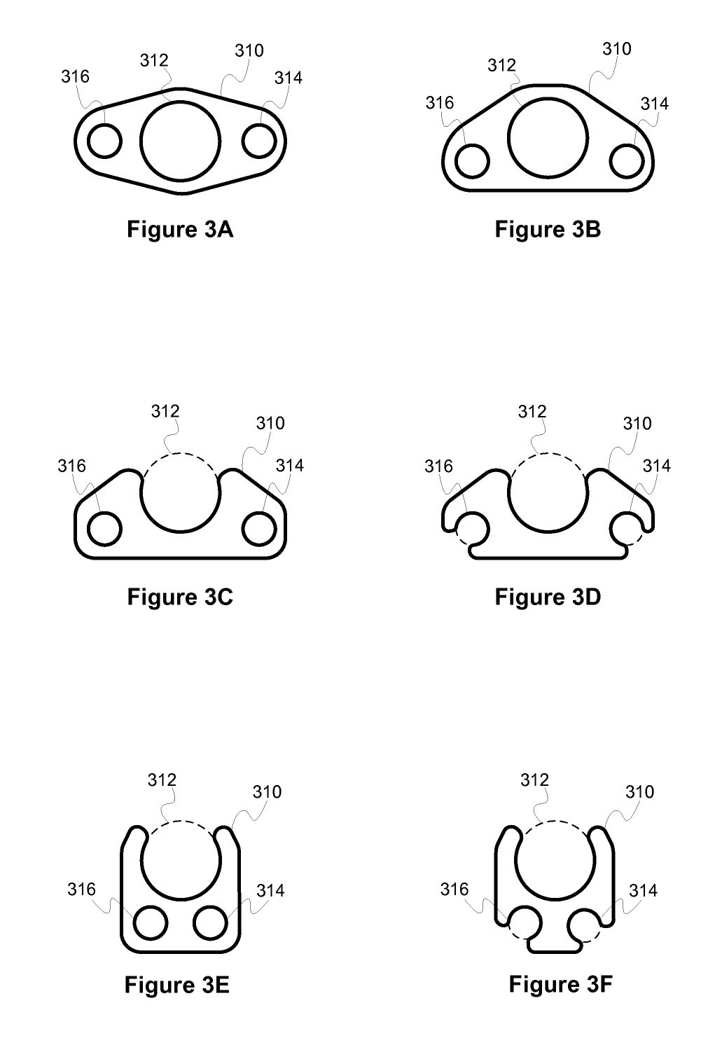

FIGS. 3A through 3F illustrate cross sections of exemplary configurations of a cable management device 310, according to one or more embodiments of the present invention. As shown, cable management device 310 includes a cavity 312 to receive an electrical jack, such as electrical jack 210, and cavities 314, 316 for passing electrical cables, such as electrical cables 222, 224. Alternatively, cavities 314, 316 may receive stems 232, 234. FIGS. 3A and 3B include cavities 312 that encircle the electrical jack, while FIGS. 3C-3F include open cavities for frictionally coupling to the electrical jack.

In use, a user may couple the electrical jack 210 to the cavity 312 of the cable management device 310, and earbuds 236, 238 to cavities 314, 316 of the cable management device 310. The earbuds 236, 238 may be coupled directly by coupling stems 232, 234 to cavities 314, 316, or indirectly by coupling electrical cables 222, 224 to cavities 314, 316. In both cases, the user forms a loop topology with the earbuds and electrical cables, thereby reducing the likelihood of a knot forming.

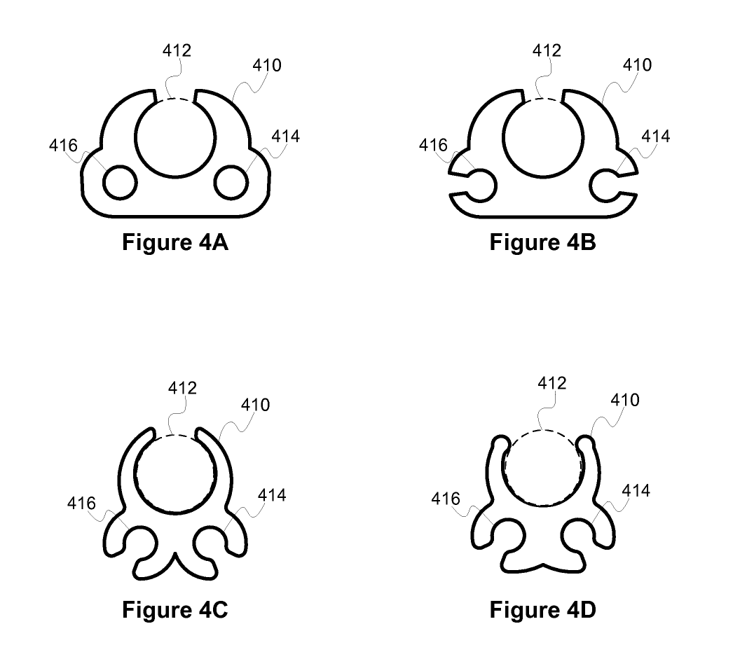

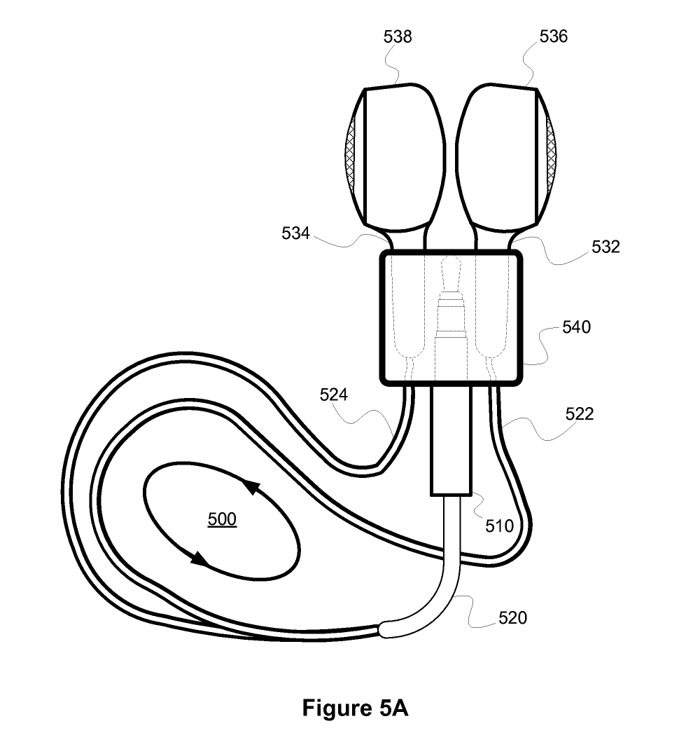

FIGS. 4A through 4D illustrate cross sections of exemplary configurations of a cable management device, according to one or more embodiments of the present invention. As shown, cable management deice 410 includes a cavity 412, configured to frictionally couple to an electrical jack, such as electrical jack 210. Cable management device 410 also includes cavities 414, 416 for coupling to electrical cables, such as electrical cables 222, 224.

In use, a user may couple the electrical jack 210 to the cavity 412 of the cable management device 410, and earbuds 236, 238 to cavities 414, 416 of the cable management device 410. The earbuds 236, 238 may be coupled directly by coupling stems 232, 234 to cavities 414, 416, or indirectly by coupling electrical cables 222, 224 to cavities 414, 416. In both cases, the user forms a loop topology with the earbuds and electrical cables, thereby reducing the likelihood of a knot forming.

FIG. 5A illustrates an earphone system in a storage configuration, according to one embodiment of the present invention. In one embodiment, the earphone system includes a cable management device 540, at least one of earbuds 536, 538, electrical cables 520, 522, 524, and electrical jack 510. Earbuds 536, 538 may comprise stems 532, 534, respectively. In one embodiment, cable management device 540 is configured to be coupled to the electrical jack 510, and to the stems 532, 534, forming loop topology 500. In this configuration, topological loose ends defined by the electrical jack 510 and earbuds 536, 538 are eliminated and the topology of the earphone system is transformed from a topological “Y” to a topological loop.

In an alternative embodiment, only one earbud is implemented and a microphone is optionally disposed along an electrical cable comprising the earphone system.

In certain embodiments, the cable management device 540 comprises a substantially extruded geometry with a cross section such as illustrated in FIGS. 3D, 4B, 4C, or 4D, whereby a center cavity is configured to be coupled the electrical jack 510, and each side cavity is configured to be coupled to a respective stem 532, 534.

FIG. 5B illustrates an alternative engagement position of the electrical jack 510 within a cable management device 540, according to one embodiment of the present invention.

FIG. 5C illustrates an alternative earbud position associated with a cable management device, according to one embodiment of the present invention.

FIG. 6A illustrates an earphone system in a storage configuration, according to one embodiment of the present invention. In one embodiment, the earphone system includes a cable management device 640, at least one of earbuds 636, 638, electrical cables 620, 622, 624, and electrical jack 610. Earbuds 636, 638 may comprise stems 632, 634, respectively. In one embodiment, cable management device 640 is configured to be coupled to the electrical jack 510, and to the earbuds 536, 538, forming a loop topology. In this configuration, topological loose ends defined by the electrical jack 610 and earbuds 636, 638 are eliminated and the topology of the earphone system is transformed from a topological “Y” to a topological loop.

In an alternative embodiment, only one earbud is implemented and a microphone is optionally disposed along an electrical cable comprising the earphone system.

FIG. 6B illustrates a cross section of an exemplary cable management device 640, according to one embodiment of the present invention. Cavity 612 may be configured to be coupled to the electrical jack 610, and each earbud 636, 638 is configured to be coupled to the cable management device 640 as shown. As shown, cavity 612 is substantially symmetrically disposed within cable management device 640. In other embodiments, cavity 612 is asymmetrically disposed within cable management device 640.

FIG. 6C illustrates a cross section of an exemplary cable management device 640, according to one embodiment of the present invention. As shown, cavity 612 is asymmetrically disposed within cable management device 640.

FIG. 7A illustrates an earphone system being disposed into a storage configuration, according to one embodiment of the present invention. In one embodiment, the earphone system includes a cable management device comprising engagement elements 750, at least one of earbuds 736, 738, electrical cables coupled to the earbuds 736, 738 and to an electrical jack (not shown). Earbuds 736, 738 may comprise stems 732, 734, respectively. In one embodiment, one or more engagement elements 750 comprising the cable management device are coupled to stems 732, 734, as shown. Alternatively, the engagement elements 750 are coupled directly to respective earbuds 736, 738. The earbuds 736, 738 may be positioned together such that the engagement elements 750 are coupled together, as shown below in FIGS. 7C, 7D, and 7H.

In an alternative embodiment, only one earbud is implemented and a microphone is optionally disposed along an electrical cable comprising the earphone system. In such an embodiment, the electrical jack may be coupled to the one earbud using engagement elements associated with the one earbud.

FIG. 7B illustrates engagement elements 750 comprising a cable management device, according to one embodiment of the present invention.

As shown, the engagement elements 750 may be fabricated to include beveled edges to facilitate alignment when brought together.

FIG. 7C illustrates engagement elements disposed to receive an electrical jack (not shown), according to one embodiment of the present invention.

FIG. 7D illustrates the engagement elements receiving an electrical jack 710, causing the earphone system to enter a storage configuration, in accordance with one embodiment of the present invention. As shown, with the electrical jack 710 coupled to the engagement elements 750, earbuds 736, 738 may be removably but firmly held together. The combined topology of the earbuds 736, 738 and associated electrical cables form a loop topology, thereby reducing the likelihood of a knot forming.

FIG. 7E illustrates a cross section of two engagement elements 750(1), 750(3) having closed engagement geometry, according to one embodiment of the present invention. A cross section of stems 732 and 734 is also shown.

FIG. 7F illustrates a cross section of two engagement elements 750(1), 750(3) having open engagement geometry, according to one embodiment of the present invention.

FIG. 7G illustrates a cross section of two engagement elements 750(1), 750(3) coupled together and ready to receive the electrical jack 710, according to one embodiment of the present invention. Electrical jack 710 may be inserted into cavity 712 to couple the electrical jack 710 to the cable management device comprising engagement elements 750.

FIG. 7H illustrates an earphone system in a storage configuration, according to one embodiment of the present invention. In this configuration, topological loose ends defined by the electrical jack 710 and earbuds 736, 738 are eliminated and the topology of the earphone system is transformed from a topological “Y” to a loop topology, thereby reducing the likelihood of knots forming in associated electrical cables 722, 724.

FIG. 8A illustrates an earphone system being disposed into a storage configuration, according to one embodiment of the present invention. In one embodiment, the earphone system includes a cable management device comprising engagement elements 860, 862, at least one of earbuds 836, 838, electrical cables coupled to the earbuds 836, 838 and to an electrical jack 810. Earbuds 836, 838 may comprise stems 832, 834, respectively. In one embodiment, one or more engagement elements 850, 862 comprising the cable management device are fabricated as part of the electrical jack 810. The cable management device is configured to removably couple each earbud 836, 838 to the electrical jack 810.

In an alternative embodiment, only one earbud is implemented and a microphone is optionally disposed along an electrical cable comprising the earphone system. In such an embodiment, the electrical jack may be coupled to the one earbud using engagement element 860.

FIG. 8B illustrates a cross section of electrical jack 810 comprising the cable management device configured to include two engagement elements 860, 862, according to one embodiment of the present invention. FIG. 8C illustrates the earphone system of FIG. 8A disposed in a storage configuration, according to one embodiment of the present invention. FIG. 8D illustrates a cross section of the electrical jack coupled to each of two earbud stems, thereby disposing the earphone system into a storage configuration, according to one embodiment of the present invention.

FIG. 8E illustrates an alternative earphone system, whereby each earbud stem 832, 834 comprises a substantially cylindrical shaft being disposed into a storage configuration, according to one embodiment of the present invention. FIG. 8F illustrates the earphone system of FIG. 8E disposed in a storage configuration, according to one embodiment of the present invention.

FIG. 9A illustrates an earphone system being disposed into a storage configuration, according to one embodiment of the present invention. In one embodiment, the earphone system includes a cable management device, at least one of earbuds 936, 938, at least one electrical cable coupled to cable 920 and to the at least one of earbuds 936, 938, and to an electrical jack 910 through cable 920. Earbuds 936, 938 may comprise stems 932, 934, respectively. In one embodiment, the cable management device comprises two attachment devices. The first attachment device includes a jack element 950 and a corresponding earbud element 960; the second attachment device includes a jack element 952 and a corresponding earbud element 962. In one embodiment, jack elements 950, 952 comprise magnets and earbud elements 960, 962 comprise magnetically permeable elements configured to magnetically attach to respective jack elements. In other embodiments, the jack elements 950, 952 comprise magnetically permeable elements and earbud elements 960, 962 comprises magnets.

In an alternative embodiment, the cable management device comprises one attachment device and only one earbud is implemented. A microphone is optionally disposed along an electrical cable comprising the earphone system. In such an embodiment, the electrical jack may be coupled to the one earbud.

FIG. 9B illustrates the earphone system of FIG. 9A disposed in a storage configuration, according to one embodiment of the present invention. FIG. 9C illustrates a cross section of the earphone system of FIG. 9A, according to one embodiment of the present invention. FIG. 9D illustrates a cross section of the earphone system of FIG. 9A, according to another embodiment of the present invention. A structural element 954 may be coupled to each jack element 950, 952. In one embodiment, the structural element 954 comprises a magnetically permeable material such as a ferromagnetic material. FIG. 9E illustrates a cross section of the earphone system of FIG. 9A, according to yet another embodiment of the present invention.

FIG. 9F illustrates a cross section of the earphone system of FIG. 9A, configured to include retention structures 970, 972, 974, 976, according to one embodiment of the present invention. FIG. 9G illustrates a cross section of the earphone system of FIG. 9A disposed in a storage configuration, according to one embodiment of the present invention.

FIG. 10A illustrates a magnetic element 1014 comprising a first attachment device, according to one embodiment of the present invention. The attachment device includes jack element 950 and earbud element 960. The earbud element 960 includes a permeable element 1010, fabricated from a magnetically permeable material such as a ferromagnetic material. The jack element 950 includes a magnetic element 1014, and a permeable form 1012, fabricated from a magnetically permeable material. The jack element 950 may also include a protective barrier 1016 configured to protect the magnet from mechanical or chemical damage. In alternative embodiments the structure indicated here as the jack element 950 is coupled to the earbud, while the structure indicated here as the earbud element 960 is coupled to an electrical jack.

Magnetic flux from the magnetic element 1014 is concentrated by the permeable form 1012 into tight loops at the interface of the magnetic element 1014 and the permeable element 1010, thereby efficiently utilizing magnetic flux generated by the magnetic element 1014.

FIG. 10B illustrates magnetic element 1014 comprising a second attachment device, according to one embodiment of the present invention. As shown, the permeable form 1012 may be shaped to partially surround the magnetic element 1014, with a gap 1020 along each edge of the magnetic element 1014. Magnetic flux 1022 is guided by the permeable form 1012 from the back side of the magnetic element 1014 to the front side of magnetic element 1014. The magnetic flux 1022 forms loops around the gap 1020 that include air in front of the magnetic element 1014 and the gap 1020. As shown, permeable element 1010 is shaped to fit tightly into the shape of the permeable form 1020, accounting for magnetic element 1014.

FIG. 10C illustrates the second attachment device being disposed into a storage configuration, according to one embodiment of the present invention. When the permeable element 1010 makes contact with the permeable form 1012, the magnetic flux 1022 is highly concentrated in the loops formed in the gap 1020, providing efficient utilization of magnetic flux generated by the magnetic element 1014.

FIG. 10D illustrates a cross section of the earphone system of FIG. 9A configured to include two instances of the second attachment device, according to one embodiment of the present invention. FIG. 10E illustrates a cross section of the earphone system of FIG. 10D disposed in a storage configuration, according to one embodiment of the present invention. A loop topology is formed by elements of the earphone system when disposed in such a storage configuration, thereby reducing the likelihood of a knot forming in associated electrical cables.

FIG. 11A illustrates an earphone system disposed in a storage configuration, according to one embodiment of the present invention. The earphone system includes at least one of earbuds 1136, 1138, electrical cables coupled to the earbuds 1136, 1138 and to an electrical jack 1110. Earbuds 1136, 1138 may comprise stems 1132, 1134, respectively. A cable management device is configured to clamp the electrical jack 1110 and each earbud 1136, 1138 together.

In an alternative embodiment, the cable management device is configured to clamp the electrical jack 1110 and one earbud. A microphone is optionally disposed along an electrical cable comprising the earphone system. In such an embodiment, the electrical jack 1110 may be coupled to the one earbud.

FIG. 11B illustrates a cross section of a cable management device, according to one embodiment of the present invention. The cable management device 1140 may include a hinge, latch, or any other technically feasible apparatus to allow a top component 1152 to be removably coupled to or closed onto a bottom component 1150. As shown, the top component 1152 may be coupled onto the bottom component 1150, thereby clamping the electrical jack 1110 and each earbud 1136, 1138 together to dispose the earphone system into a storage configuration. As a result, a loop topology is formed for the storage configuration. FIG. 11C illustrates a cross section of the cable management device disposed in a storage configuration, according to one embodiment of the present invention.

FIG. 110 illustrates a cross section of the cable management device 1140 of FIG. 11A configured to include magnetic attachment devices, according to one embodiment of the present invention. Each magnetic attachment device may include a magnetic element 1170 and a permeable element 1172. As shown, the electrical jack 1110 and each earbud 1136, 1138 may be magnetically coupled to the bottom component 1150. The top component 1152 may then be used to clamp the electrical jack 1110 and each earbud 1136, 1138 together to dispose the earphone system into a storage configuration comprising a loop topology.

FIG. 12A illustrates a cable management device disposed in a storage configuration, according to one embodiment of the present invention. The cable management device comprises a central element 1274 and a sack structure for each earbud. An electrical jack 1210 may be removably coupled to the central element 1274 as part of a storage configuration.

FIG. 12B illustrates the cable management device of FIG. 11A prepared to dispose an earphone system into a storage configuration, according to one embodiment of the present invention. As shown, earbud 1236 may be inserted into sack structure 1270 and earbud 1238 may be inserted into sack structure 1272. With each earbud stored within a corresponding sack structure and the electrical jack 1210 coupled to the central element 1274, the earphone system comprises a loop topology.

In the above embodiments illustrated in FIGS. 2A-12, an earphone system comprises an electrical jack configured to transmit an electrical signal from an audio host, such as a mobile music player, to an electrical cable. An earbud is coupled to the electrical cable an configured to convert the electrical signal to an acoustic signal. A user may couple the earbud to their ear and listen to the acoustic signal, which may transmit music, voice, and/or other audio signals. A cable management device is coupled to the electrical jack and to the earbud to configure the electrical cable into a loop topology. While configured into a loop topology, such as for storage, the electrical cable is advantageously less likely to form knots compared to an un-looped topology (e.g., a “Y” topology or line topology).

While the foregoing is directed to embodiments of the present invention, other and further embodiments of the invention may be devised without departing from the basic scope thereof, and the scope thereof is determined by the claims that follow.

We claim:

1. An earphone system, comprising:
an electrical jack configured to transmit a first electrical signal from an audio host to a first electrical cable;
a first earbud coupled to the first electrical cable, wherein the first earbud is configured to convert the first electrical signal into a first acoustic signal; and
a cable management device coupled to the electrical jack and to the first earbud,
wherein the cable management device is configured to form the first electrical cable into a loop topology.

2. The earphone system of claim 1, further comprising:
a second electrical cable configured to transmit a second electrical signal from the electrical jack to a second earbud,
wherein the cable management device is configured to form the second electrical cable into a loop topology.
